(19) United States
(12) Patent Application Publication
(10) Pub. No.: US 2010/0102698 A1
(43) Pub. Date: Apr. 29, 2010

(54) HIGH REFRACTIVE INDEX MATERIALS FOR ENERGY EFFICIENT LAMPS

(76) Inventors: Zhibo Zhao, Novi, MI (US); Rajasingh Schwartz Israel, Westlake, OH (US); Tianji Zhao, Mayfield Heigths, OH (US); Brett Allan Guhde, South Euclid, OH (US)

Correspondence Address: General Electric Company;GE Global Patent Operation, 2 Corporate Drive, Suite 648, Shelton, CT, 06484, US

(21) Appl. No.: 12/256,620

(22) Filed: Oct. 23, 2008

(51) Int. Cl. H01K 1/26; B32B 9/00

(52) U.S. Cl. 313/112; 428/697; 428/220

(57) ABSTRACT

Disclosed herein are optical interference multilayer coatings comprising a plurality of alternating low refractive index and high refractive index layers, where the high refractive index layers comprise at least one mixed metal oxide selected from: NbTaX oxide where X is selected from the group consisting of Hf, Al and Zr; NbTiY oxide where Y is selected from the group consisting of Ta, Hf, Al and Zr; and TiAlZ oxide where Z is selected from the group consisting of Ta, Hf and Zr. Also disclosed herein are lamps comprising a light-transmissive envelope, at least a portion of the surface of the light-transmissive envelope being provided with the optical interference multilayer coating noted above. Such coatings, when used on lamps, may advantageously offer improved energy efficiencies for such lamps.

### FIELD OF THE INVENTION

The present invention generally relates to optical multilayer coatings having high refractive index layers. In particular, some embodiments herein relate to optical multilayer coatings having high refractive index layers comprising oxides of at least three metals.

### BACKGROUND

Optical interference coatings, sometimes also referred to as thin film optical coatings or filters, comprise alternating layers of two or more materials of different indices of refraction. Such coatings or films are known, and have been used to selectively reflect or transmit light radiation from various portions of the electromagnetic radiation spectrum, such as ultraviolet, visible and infrared radiation. For instance, such optical interference coatings are used in the lamp industry to coat reflectors and lamp envelopes. One application in which optical interference coatings are useful is to improve the illumination efficiency, or efficacy, of lamps by reflecting infrared energy emitted by a filament, or arc, toward the filament or arc while transmitting visible light of the electromagnetic spectrum emitted by the light source. This decreases the amount of electrical energy required to be supplied to the light source to maintain its operating temperature.

The optical interference coatings generally comprises two different types of alternating layers, one having a low refractive index and the other having a high refractive index. With these two materials having different indices of refraction, an optical interference coating, which can be deposited on the outer surface of the lamp envelope, can be designed. In some cases, the coating or filter transmits the light in the visible spectrum region (generally from about 380 to about 780 nm wavelength) emitted from the light source while it reflects the infrared light (generally from about 780 to about 2500 nm). The returned infrared light heats the light source during lamp operation and, as a result, the lumen output of a coated lamp is considerably greater than the lumen output of an uncoated lamp.

Many known high refractive index materials, when used as components of optical interference coatings, cannot preserve their optical and mechanical integrities at lamp operating temperatures. The problems are often manifested as loss of visible light transmission, degradations in reflectance of IR radiation (where such reflectance is desired), and or coating failures in the forms of excessive cracking and delamination. However, in order to achieve high energy efficiencies, these varying degrees of degradation in optical and mechanical integrities cannot be tolerated.

Accordingly, there remains a need for optical interference multilayer coatings having enhanced optical and mechanical integrities at high temperatures, such as, for example, as high as about 400° C., or up to about 1000° C.

### BRIEF SUMMARY OF THE INVENTION

One embodiment of the present invention is directed to an optical interference multilayer coating comprising a plurality of alternating first and second layers. The first layers have a relatively low refractive index and the second layers have a relatively higher refractive index than the first layers. The second layers comprise at least one mixed metal oxide selected from: NbTaX oxide where X is selected from the group consisting of Hf, Al and Zr; NbTiY oxide where Y is selected from the group consisting of Ta, Hf, Al and Zr; and TiAlZ oxide where Z is selected from the group consisting of Ta, Hf and Zr.

A further embodiment of the present invention is directed to a lamp comprising a light-transmissive envelope having a surface, and a light source, with the envelope at least partially enclosing the light source. At least a portion of the surface of the light-transmissive envelope is provided with an optical interference multilayer coating comprising a plurality of alternating first and second layers, the first layers having relatively low refractive index and the second layers having relatively higher refractive index than the first layers. The second layers comprise at least one mixed metal oxide selected from: NbTaX oxide where X is selected from the group consisting of Hf, Al and Zr; NbTiY oxide where Y is selected from the group consisting of Ta, Hf, Al and Zr; and TiAlZ oxide where Z is selected from the group consisting of Ta, Hf and Zr.

Other features and advantages of this invention will be better appreciated from the following detailed description.

### BRIEF DESCRIPTION OF THE DRAWINGS

Embodiments of the invention will now be described in greater detail with reference to the accompanying Figures.

FIG. 1 is a schematic depiction of an exemplary lamp, in accordance with embodiments of the invention.

FIG. 2 is a graph depicting optical performance after annealing of a multilayer coating comprising Nb, Ti, and Al, in accordance with embodiments of the invention.

FIG. 3 is a graph showing optical performance after annealing of a two-component multilayer coating comprising Nb and Ta.

FIG. 4 is a graph showing optical performance after annealing of a single layer coating comprising Ti, Al, and Ta, in accordance with embodiments of the invention.

FIG. 5 is a graph showing optical performance after annealing of another single layer coating comprising Ti, Al, and Hf, in accordance with embodiments of the invention.

FIG. 6 is a graph showing optical performance after annealing of another single layer coating comprising Nb, Ti and Al, in accordance with embodiments of the invention.

FIG. 7 is a graph showing optical performance after annealing of a two-component single-layer coating comprising Nb and Ta.

### DETAILED DESCRIPTION

As noted, an embodiment of the invention is directed to an optical interference multilayer coating comprising a plurality of alternating first and second layers, the first layers having relatively low refractive index and the second layers having relatively higher refractive index than the first layers, wherein the second layers comprise at least one mixed metal oxide selected from: NbTaX oxide where X is selected from the group consisting of Hf, Al and Zr; NbTiY oxide where Y is selected from the group consisting of Ta, Hf, Al and Zr; and TiAlZ oxide where Z is selected from the group consisting of Ta, Hf and Zr. Stated differently, the second layers comprise at least one mixed metal oxide selected from NbTaHf oxide, NbTaAl oxide, NbTaZr oxide, NbTiTa oxide, NbTiHf oxide, NbTiAl oxide, NbTiZr oxide, TiAlTa oxide, TiAlHf oxide, and TiAlZr oxide; or the like. Coatings according to embodiments of the invention can be utilized for any of a wide variety of applications where optical interference coatings are desired or typically used. These include, for example, lighting applications (e.g., lamps), optical waveguides, reflectors, decorative materials, security printing; or the like. In some embodiments the coatings are used to selectively reflect one portion of the electromagnetic spectrum while transmitting another portion of the electromagnetic spectrum. For instance, the coatings can be used as a “cold mirror” or a “hot mirror”. A “cold mirror” is an optical filter that reflects visible light while at the same time permitting longer wavelength infrared energy to pass through the filter. A “hot mirror” is an optical filter that reflects infrared radiation while at the same time permitting shorter wavelength visible light to pass through the filter. One nonlimiting application of hot mirrors herein is to return infrared heat to the filament of a lamp in order to increase lamp efficiency.

The multilayer materials according to embodiments of the invention comprise layers having relatively higher refractive index, wherein these high index layers comprise at least one mixed metal oxide. As used herein, the term “mixed metal oxide” may be defined in terms of being mixtures of metal oxides; solid solutions of metal oxides; stoichiometric or nonstoichiometric compounds of metal oxides; or combinations of the foregoing. Typically, the mixed metal oxides used according to embodiments of the invention comprise at least three different types of metal atoms in the oxide. For instance, and by way of example only, a “NbTiHf oxide” is intended to refer to any one or more of the following: (1) a mixture comprising a niobium oxide, a titanium oxide, and a hafnium oxide; (2) a solid solution of Nb₂O₅, TiO₂ and HfO₂; (3) a compound NbₐTi_{b}Hf_{c}O_{d} where a, b and c are positive real numbers and d=2.5a+2b+2c (when Nb is pentavalent) or d=1.5a+2b+2c (when Nb is trivalent); (4) an oxygen-deficient nonstoichiometric compound NbₐTi_{b}Hf_{c}O_{d+δ} where a, b, c, d are as above and 6 is less than about 0.2; (5) an oxygen-excess nonstoichiometric compound NbₐTi_{b}Hf_{c}O_{d+δ} where a, b, c, d and δ are as above; or combinations of the foregoing; or the like. For instance, a “NbTiHf oxide” may comprise discrete molecules of the respective oxides (e.g., as in a mixture); or may be an oxide of an Nb/Ti/Hf matrix. The same possibilities exist for the other mixed metal oxides used according to embodiments of the invention that comprise at least three different types of metal atoms in the oxide.

In general, the second (i.e., high refractive index) layer of the optical interference multilayer coating may comprise at least one mixed metal oxide selected from: NbTaX oxide satisfying the atom ratio 0<X/(Nb+Ta+X)<1; NbTiY oxide satisfying the atom ratio 0<Y/(Nb+Ti+Y)<1; and TiAlZ oxide satisfying the atom ratio 0<Z/(Ti+Al+Z)<1; where X, Y and Z are as above.

The use of optical interference coatings according to embodiments of the invention, which comprise at least three different types of metal atoms in the mixed metal oxide, may have certain advantages. Such coatings, when used on lamps, may advantageously offer improved energy efficiencies for such lamps. Such improvement may be manifest in an increased value for LPW (lumen per watt). Furthermore, such coatings may also exhibit high structural and optical integrity even after exposure to high temperatures. Yet furthermore, lamps coated with optical interference films in accordance with embodiments of the present invention may exhibit improved consistency and performance stability, and have an improved appearance (smooth and clear coating surface). Without being limited by theory, the inclusion of element “X”, “Y” and “Z” may act as a stabilizer for the high index layers, such that crystallization or grain growth of mixed metal oxides at high temperatures substantially does not occur. Such crystallization or grain growth has heretofore been known as being one cause of deleterious light scattering in metal oxide materials. Light scattering in metal oxide materials can lead to loss in transmittance of light where high light transmittance is a desired property.

In some embodiments, the second (i.e., high refractive index) layer of the optical interference multilayer coating may comprise at least one mixed metal oxide selected from: NbTaX oxide satisfying the atom ratio 0<X/(Nb+Ta+X)<0.30; NbTiY oxide satisfying the atom ratio 0<Y/(Nb+Ti+Y)<0.30; and TiAlZ oxide satisfying the atom ratio 0<Z/(Ti+Al+Z)<0.30; where X, Y and Z are as above. In a further embodiment, the second (i.e., high refractive index) layer of the optical interference multilayer coating may comprise at least one mixed metal oxide selected from: NbTaX oxide satisfying the atom ratio 5<X/(Nb+Ta+X)<0.25; NbTiY oxide satisfying the atom ratio 5<Y/(Nb+Ti+Y)<0.25; and TiAlZ oxide satisfying the atom ratio 5<Z/(Ti+Al+Z)<0.25. Other metal atoms may be present in each of these mixed metal oxides, but for purposes of measuring the atom ratio, only the atom amount of the recited metals is used. In certain embodiments, the high index layers of the optical interference multilayer coatings have a refractive index of from about 1.7 (or above about 1.7) to about 2.8 when measured using visible light having a wavelength of 550 nm.

It is typical that the first (i.e., low refractive index) layers according to embodiments of the invention are composed of a material having a relatively low refractive index, e.g., a refractive index of from about 1.35 to about 1.7 at 550 nm. Such low refractive index materials may include a wide variety of ceramic and/or refractory materials such as metal or metalloid oxides or nitrides. However, it is sometimes convenient to employ a silicon oxide (e.g., silica or quartz) as the low refractive index material from which the first layers are composed. It is typical, although not always necessary, that the first and second layers are both alternating and adjacent.

According to embodiments of the invention, the optical interference multilayer coating may have a total geometrical thickness that varies in a wide range. It may be up to about 25 microns, or may be as low as about 0.001 microns. For example, and not by way of limitation, the total geometrical thickness may be in a range of from about 1 to about 15 microns. Stated more narrowly, the optical interference multilayer coating may also have a total geometrical thickness of from about 10 to about 15 microns. The individual high and low refractive index layers may typically have a thickness of from about 20 nm to about 500 nm, or sometimes from about 10 nm to about 200 nm.

According to embodiments of the invention, the optical interference multilayer coating may comprise any arbitrary total number of layers (high and low index) above two. The total number of layers is not particularly critical. More particularly, the total number of layers may range from any integer from 4 to 250 inclusive, and stated more narrowly, from about 30 to about 150 layers.

In accordance with certain embodiments, the optical interference multilayer acts as a “hot mirror”, i.e., it transmits light in the visible spectrum region (generally from about 380 to about 780 nm wavelength) emitted from a light source while it reflects infrared light (generally from about 780 to about 2500 nm). In such embodiments, the optical interference multilayer coating may have an average transmittance in visible light of greater than 60% (more preferably, greater than about 80%) and have an average reflectance of at least about 30% (and more usually, greater than about 70%) in the infrared region of the electromagnetic spectrum.

By use of the high refractive index materials disclosed herein for the high index layer of optical interference coatings, one can obtain a material which can resist frequent temperature changes, especially changes which include increases to 800° C. or higher. One manifestation of such high temperature resistance is that coatings according to embodiments of the present invention often do not suffer from excessive delamination or cracking. For instance the optical interference multilayer coating is typically capable of repeated cycling between room temperature and greater than or equal to about 800° C. without significant mechanical degradation of the second (high index) layers; or of the first layers; or both.

Another manifestation of enhanced temperature resistance is that coatings according to embodiments of the present invention often do not suffer from excessive light scattering in the visible region. Without being limited by any theory, it is believed that as high index layers experience high temperatures, the layers undergo a transformation to a more crystalline structure (or a structure with larger grain sizes), both of which can enhance light scattering and thus reduce light transmittance through the layers in the visible region, especially around 370 to 500 nm wavelength. As mentioned earlier, the inclusion of element “X”, “Y” and “Z” may offer the technical effect (advantage) of acting as a stabilizer for the high index layers, such that crystallization or grain growth of mixed metal oxides at high temperatures substantially does not occur. For example, the optical interference multilayer coating according to embodiments of the invention typically exhibits a transmission loss of less than about 10% (and more narrowly, less than about 5%) in the visible region of the electromagnetic spectrum after undergoing annealing at about 800° C. for about 4 d. In some embodiments, the transmission loss is less than about 5% in the visible spectrum even after annealing at 800° C. for greater than 4 days. In yet further embodiments, the transmission loss is less than about 5 to 10% even after annealing at greater than 800° C., such as, for example, at 850, 900, 950, and 1000° C. In fact, the optical performance of the multilayer coating can sometimes last as long as the entire life of lamps onto which it may be applied, for instance, about 3000 h.

The multilayer coatings according to embodiments of the invention may be deposited by any suitable deposition technique known for depositing coating materials. Exemplary techniques may include, but are not limited to: chemical vapor deposition (e.g., low pressure CVD, LPCVD) and plasma-assisted chemical vapor deposition; and physical vapor deposition methods such as thermal evaporation, electron beam evaporation, ion plating, dip coating, ion beam deposition, sputtering, spray coating, or laser ablation; or the like.

Where LPCVD is used to deposit multilayer coatings, it may typically employ the process as set forth in U.S. Pat. No. 5,143,445, pertinent teachings of which are hereby incorporated by reference. However, the thickness limit for an optical interference coating on a lamp produced by LPCVD may be only about four microns. If thicker layers are desired, sputtering techniques can also be used to coat lamps. A typical sputtering device includes a chamber housing at least one target and a substrate. A gas, such as argon, is introduced into the chamber that becomes positively ionized. The positive argon ions bombard the target causing deposition material to be removed and condense into a thin film on the substrate. Some suitable sputtering devices include the radio frequency (RF) magnetron sputtering device shown in U.S. Pat. No. 6,494,997, pertinent teachings of which are hereby incorporated by reference. Sputtering techniques and equipment are well known in the art. For example, magnetron sputtering chambers and related equipment are available from a variety of sources.

When sputtering is employed, one may use a single target holding an alloy and/or mixture of the metals used for forming the mixed metal oxide of the high refractive index layer. Alternatively, multiple targets, each holding one or more metals, can be used. Yet furthermore, one or more targets containing a metal oxide or other compound can also be used. In general, such sputtering operations are typically carried out in an oxygen/argon atmosphere. Where the intended use of the coating is to act as a bandpass filter for a light source or lamp, the substrate which is coated may typically include a light-transmissive envelope of a lamp.

In accordance with embodiments of the invention, there are also provided a lamp or lamps including the optical interference multilayer coatings of the present disclosure. Such lamps generally comprise a light-transmissive envelope having a surface, and a light source, with the envelope at least partially enclosing the light source. At least a portion of the surface of the light-transmissive envelope is provided with the optical interference multilayer coating. As is generally known, such light-transmissive envelopes may be composed of any material which is light transmissive to an appreciable extent and is capable of withstanding relatively hot temperature (e.g., about 800° C. or even above); for example, it may be composed of quartz, ceramic, or glass; or the like. The light source may be an incandescent source (for example, one which provides light through resistive heating of a filament); and/or it may be an electric arc discharge source, such as a high-intensity discharge (HID) source.

Usually, where a filament is employed, it is composed of a refractory metal, generally in coiled form, such as tungsten or the like, as is well known. To energize the lamp, there is typically provided at least one electric element arranged in the envelope and connected to current supply conductors (or electrical leads) extending through the envelope. Usually, the envelope encloses a fill gas, especially, an ionizable fill gas, which may comprise at least one rare gas (such as krypton or xenon), and/or a vaporizable halogen substance, such as an alkyl halide compound (e.g., methyl bromide). Other fill compositions are also contemplated, such as metal halides, mercury, and combinations thereof.

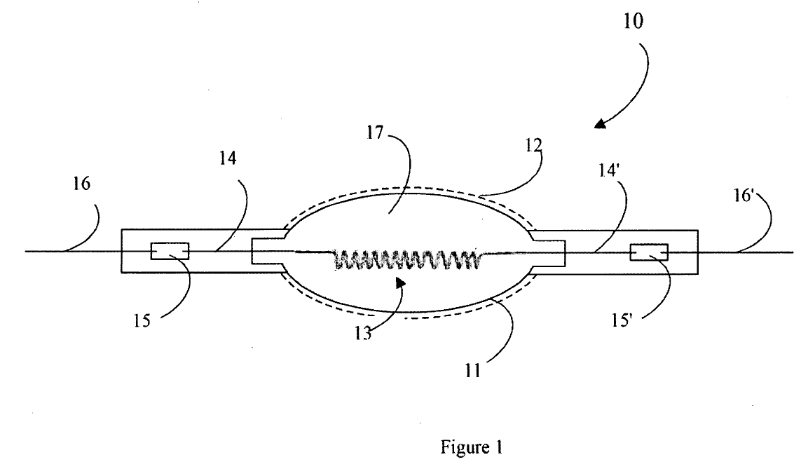

Referring now to FIG. 1, here is shown a schematic depiction of an exemplary lamp in accordance with embodiments of the invention. It is not intended to be limiting, and is not a scale drawing. In this illustrative embodiment, lamp 10 comprises a hermetically sealed, vitreous, light transmissive quartz envelope 11, the outer surface of which is coated with a multilayer optical interference coating 12. Envelope 11 encloses coiled tungsten filament 13 which can be energized by inner electrical leads 14,14′. The inner electrical leads 14,14′ are welded to foils 15,15′, and outer electrical leads 16,16′ are welded to the opposite ends of the foils. In the interior 17 of envelope 11 is disposed an ionizable fill comprising a halogen or halogen compound.

### EXAMPLES

These examples are illustrative, and should not be construed to be any sort of limitation on the scope of the claimed invention.

Embodiments of this invention typically offer surprising and unexpected advantages when compared with multilayer optical interference coatings having only two or fewer metals in the high index material of the coatings. Examples of such surprising and unexpected advantages are disclosed herein, and they are not to be construed as limiting the invention.

### Example 1

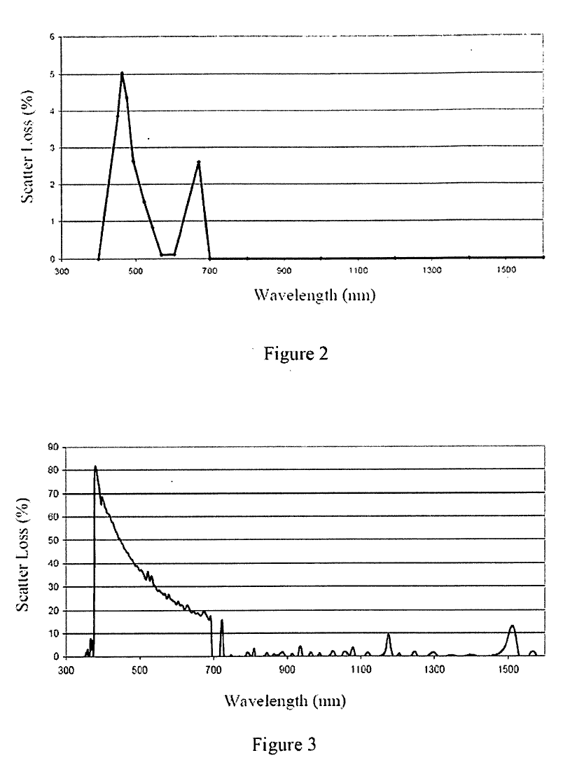

An exemplary multilayer material (36 layers) was deposited as a coating on a substrate. It had a total geometric thickness of about 4 microns and was made of alternating high refractive layers and low refractive index layers. The low refractive index layers were composed of silica, and the high refractive index layers were sputter-deposited NbTiAl oxide. The high refractive index material was deposited by sputtering of a combination of metallic Nb, Ti and Al in a mass ratio of 45:45:10, held in a target. By formulation, the deposited NbTiAl oxide material was estimated to be nominally composed of about 20.6 atom % Al based on the total number of metallic atoms, i.e. the NbTiAl oxide material satisfies the atom ratio Al/(Nb+Ti+Al)=about 0.206. This material was then annealed at a temperature of 800° C. for 4 days, and its transmittance spectrum was compared to the as-deposited coating. It was found that the annealed coating has very little light scattering in the visible region. This was evidenced by a transmittance loss of no more than about 5% in the region between 450-500 nm, almost 0% for IR wavelengths about 700 nm, and no more than about 2.5% for other visible and IR wavelengths. See FIG. 2. Furthermore, the coating did not suffer from delamination.

### Example 2

In contrast, high refractive index materials composed of two component oxides did not exhibit similarly beneficial levels of low light scattering and high mechanical stability. For example, a multilayer material (120 layers) made of alternating high refractive layers and low refractive index layers, was deposited as a coating upon a substrate, where the low refractive index layers were composed of silica, and the high refractive index layers comprised sputter-deposited NbTa oxide. The coating was then annealed at 800° C. for just 1 day. Light transmittance for the annealed coating was compared to the as-deposited coating. The loss in transmittance for the annealed coating in the visible wavelength range was significant and dramatically worse as compared with the three-component material tested above, as shown in FIG. 3. In the wavelength range of from about 400-700 nm, the loss was in the 7-50% range measured as sphere loss, and in the 17-80% range measured as specular loss. FIG. 3 shows the scatter loss measured in specular mode.

### Example 3

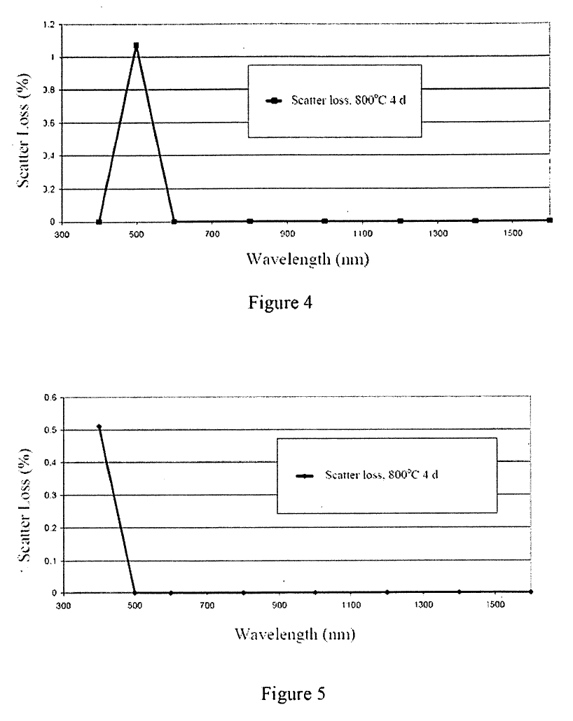

Another embodiment of the invention involved a three-component high index layer comprising a TiAlTa oxide. A single layer of this material was deposited by sputtering and then annealed for a total of 4 d at 800 C. Its loss in transmittance after the 4-day annealing was no more than about 1.5% over the visible and IR regions. See FIG. 4.

### Example 4

Similarly, a three-component high index single layer comprising a TiAlHf oxide was deposited by sputtering and then annealed for a total of 4 d at 800 C. Its loss in transmittance due to light scattering was no more than about 0.5% even after suffering the 4 days of annealing, as shown in FIG. 5.

### Example 5

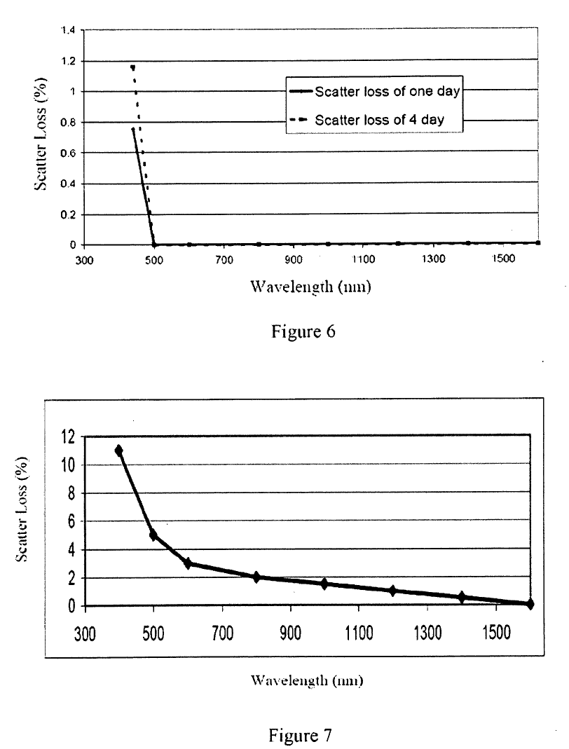

In this example, a single layer comprising NbTiAl oxide was deposited as a coating on a substrate, and then annealed at 800 C for 1 day and then for a total of 4 days. The maximum loss in light transmittance (scatter loss) was no more than about 1.2%. See FIG. 6.

### Example 6

In contrast to the single-layer three component high index layers described above, a single-layer two component study was also conducted. A single layer of high index NbTa oxide was deposited on a substrate by sputtering, and then annealed for 1 d at 800 C. Its light scattering loss after 1 day annealing was as high as about 11% in the visible region, as shown in FIG. 7.

The above-described optical interference films, when used as coatings on lamps, may advantageously offer improved energy efficiencies for such lamp, e.g. halogen lamps. Such improvement may be manifest in an increased value for LPW (lumen per watt). When expressed as percent, the increase in LPW is referred to as “gain”. Lamps when coated with optical interference films, in accordance with embodiments of the present invention, may exhibit a gain of from about 20% to about 150%, more preferably greater than about 33%, and even more preferably from about 100% to about 150%, versus uncoated lamps. Such comparisons are typically performed on the same lamps energized to the same hot filament temperature, e.g., at the temperature of usual operation. Furthermore, the above-described optical interference films may also exhibit high structural and optical integrity even after exposure to temperatures up to about 800° C. or even higher.

Yet furthermore, lamps coated with optical interference films in accordance with embodiments of the present invention, may exhibit improved consistency and performance stability, and have an improved appearance (smooth and clear coating surface).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” used in connection with a quantity is inclusive of the stated value and has the meaning dictated by the context (for example, includes the degree of error associated with the measurement of the particular quantity). “Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present. The singular forms “a”, “an” and “the” include plural referents unless the context clearly dictates otherwise. All ranges disclosed herein are inclusive of the recited endpoint and independently combinable.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. An optical interference multilayer coating comprising,
a plurality of alternating first and second layers, said first layers having relatively low refractive index and said second layers having relatively higher refractive index than the first layers,
wherein said second layers comprise at least one mixed metal oxide selected from:
NbTaX oxide where X is selected from the group consisting of Hf, Al and Zr;
NbTiY oxide where Y is selected from the group consisting of Ta, Hf, Al and Zr; and
TiAlZ oxide where Z is selected from the group consisting of Ta, Hf and Zr.

2. The optical interference multilayer coating according to claim 1,
wherein said second layers comprise at least one mixed metal oxide selected from:
NbTaX oxide satisfying the atom ratio 0<X/(Nb+Ta+X)<1;
NbTiY oxide satisfying the atom ratio 0<Y/(Nb+Ti+Y)<1; and
TiAlZ oxide satisfying the atom ratio 0<Z/(Ti+Al+Z)<1.

3. The optical interference multilayer coating according to claim 2,
wherein said second layers comprise at least one mixed metal oxide selected from:
NbTaX oxide satisfying the atom ratio 5<X/(Nb+Ta+X)<0.25;
NbTiY oxide satisfying the atom ratio 5<Y/(Nb+Ti+Y)<0.25; and
TiAlZ oxide satisfying the atom ratio 5<Z/(Ti+Al+Z)<0.25.

4. The optical interference multilayer coating according to claim 1, wherein said coating is capable of repeated cycling between room temperature and greater than or equal to about 800° C. without significant mechanical degradation of said second layers.

5. The optical interference multilayer coating according to claim 1, wherein said coating exhibits a transmission loss of less than about 5% in the visible region of the electromagnetic spectrum after annealing at about 800° C. for about 4 d.

6. The optical interference multilayer coating according to claim 1, wherein said second layers have a refractive index of from about 1.7 to about 2.8 at 550 nm.

7. The optical interference multilayer coating according to claim 1, wherein said first layers have a refractive index of from about 1.35 to about 1.7 at 550 nm.

8. The optical interference multilayer coating according to claim 1, wherein said coating has a geometrical thickness of from about 0.001 to about 25 microns.

9. The optical interference multilayer coating according to claim 8, wherein said coating has a geometrical thickness of from about 1 to about 15 microns.

10. The optical interference multilayer coating according to claim 1, wherein said coating has a total number of layers of from 4 to 250.

11. The optical interference multilayer coating according to claim 1, wherein said coating has an average transmittance in visible light of greater than 60% and has an average reflectance of at least about 30% in the infrared region of the electromagnetic spectrum.

12. An optical interference multilayer coating comprising,
a plurality of alternating first and second layers, said first layers having relatively low refractive index and said second layers having relatively higher refractive index than the first layers,
wherein said second layers comprise at least one mixed metal oxide selected from: NbTiAl oxide satisfying the atom ratio 0<Al/(Nb+Ta+Al)<1; TiAlTa oxide satisfying the atom ratio 0<Ta/(Ti+Al+Ta)<1; and TiAlHf oxide satisfying the atom ratio 0<Hf/(Ti+Al+Hf)<1.

13. A lamp comprising:
a light-transmissive envelope having a surface; and a light source, said envelope at least partially enclosing said light source;
wherein at least a portion of the surface of the light-transmissive envelope is provided with an optical interference multilayer coating comprising a plurality of alternating first and second layers, said first layers having relatively low refractive index and said second layers having relatively higher refractive index than the first layers,
wherein said second layers comprise at least one mixed metal oxide selected from: NbTaX oxide where X is selected from the group consisting of Hf, Al and Zr; NbTiY oxide where Y is selected from the group consisting of Ta, Hf, Al and Zr; and TiAlZ oxide where Z is selected from the group consisting of Ta, Hf and Zr.

14. The lamp according to claim 13, wherein said second layers comprise at least one mixed metal oxide selected from:
NbTaX oxide satisfying the atom ratio 0<X/(Nb+Ta+X)<0.30;
NbTiY oxide satisfying the atom ratio 0<Y/(Nb+Ti+Y)<0.30; and
TiAlZ oxide satisfying the atom ratio 0<Z/(Ti+Al+Z)<0.30.

15. The lamp according to claim 13, wherein said coating is capable of repeated cycling between room temperature and about 800° C. without significant mechanical degradation of the first and second layers.

16. The lamp according to claim 13, wherein said coating exhibits a transmission loss of less than about 5% in the visible region of the electromagnetic spectrum after annealing at about 800 C for about 4 d.

17. The lamp according to claim 13, wherein said light source comprises a filament and wherein said lamp, when energized to a hot filament temperature, exhibits an LPW gain of from about 20% to about 150% as compared to the same lamp energized to the same hot filament temperature without said coating.

18. The lamp according to claim 13, further comprising at least one electric element arranged in the envelope and connected to current supply conductors extending through the envelope.

19. The lamp according to claim 13, wherein the light source comprises one or more of filament or electric arc.

20. The lamp according to claim 13, wherein the envelope encloses a fill gas comprising a halogen-containing gas.
